(19) United States
(12) Patent Application Publication
(10) Pub. No.: US 2005/0091159 A1
(43) Pub. Date: Apr. 28, 2005

(54) Bill handling apparatus

(76) Inventors: Hiroshi Ichikawa, Owariasahi (JP); Riichi Katou, Nagoya (JP); Mizuki Kall, Nagoya (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/974,800

(22) Filed: Oct. 28, 2004

(30) Foreign Application Priority Data
Oct. 28, 2003 (JP) 2003-367169

(51) Int. Cl. G06F 17/60

(52) U.S. Cl. 705/40; 705/39

(57) ABSTRACT

The object of the present art is to continue bill payment dealings even after a jam has occurred in a bill conveyance mechanism. Moreover, the present art is outlined below. An upper mechanism at least having a bill depositing and payment slot that temporarily sets a bill deposited from or paid to a user, a first conveyance path through which the bill is conveyed from or to the bill depositing and payment slot, and a discrimination unit that discriminates the bill is provided. A lower mechanism at least having a recycling box that stores the received or paid bill, and a second conveyance path that is linked with the recycling box and the first conveyance path and conveys the bill is provided. A detector that detects an abnormal condition of the bill arranged in the upper mechanism and the lower mechanism, a payment mechanical unit that is linked with the second conveyance path of the lower mechanism and ejects the bill for the user, and a control unit that receives a signal from the detector and determines the abnormal condition are provided. If the control unit determines the abnormal condition as an abnormality in the upper mechanism, a function of the upper mechanism is stopped, the second conveyance path and the payment mechanical unit are operated, and the bill is dispatched from the recycling box to be conveyed into the payment mechanical unit and ejected.

### CROSS-REFERENCE TO RELATED APPLICATION

This application claims the benefit of priority of Japanese Application No. 2003-367169 filed on Oct. 28, 2003, the disclosure of which also is entirely incorporated herein by reference.

### BACKGROUND OF THE INVENTION

The present art relates to a bill handling apparatus, and, more particularly, to bill payment handling when a bill jam has occurred in an ATM (Automated Teller Machines) in case of bill dealings.

An ATM (automated teller machine) used in a financial institution is provided with a recycling box that stores bills for depositing and payment. When a user puts a bill into a bill depositing and payment slot in depositing, the bill is conveyed into a discrimination unit and discriminated, and only an adapted bill is stored in the recycling box. On the other hand, in payment, the bill for a sum specified by the user is dispatched from the recycling box, and discriminated in the discrimination unit. Subsequently, the bill is set temporarily in the bill depositing and payment slot, and paid to the user.

Incidentally, in an ATM, a jam may occur in some cases on a conveyance path with regard to a deposited bill or a bill dispatched from a recycling box. When the jam has occurred in the deposited and paid bills, the jam is removed by a maintenance engineer. Accordingly, until the bill handling apparatus is recovered, bill depositing and payment dealings cannot help stopping. Consequently, the convenience of a user is impaired, and the operating ratio of the ATM is also reduced.

An art that copes with the occurrence of a bill jam in a cash machine for a bill is disclosed in Japanese Published Unexamined Patent Application No. Hei 5-81507, for example. This art relates to a dedicated payment machine, and this machine provides a bill releasing slot having a bill accumulation unit respectively corresponding to a safe box that stores the bill per denomination. When the payment operation of the bill is disabled from the safe box of a certain denomination due to the occurrence of the jam, this machine performs the bill payment operation from another safe box instead of the bill of the denomination.

### SUMMARY OF THE INVENTION

According to the art disclosed in the above patent reference, a bill releasing slot is provided per safe box of each denomination. Accordingly, as many bill conveyance paths, reject boxes, and bill sensors as safe boxes are required, and a bill handling apparatus is made large-sized as a whole. Moreover, usually, when the bill is independently released respectively from multiple releasing slots, a user must receive the bill from each releasing slot. This operation is troublesome the user, and, by the same token, it is easy to forget to receive the bill.

Moreover, the art disclosed in a patent document presupposes that a jam will occur in a safe box of a certain denomination, and degenerates the safe box. When the jam has occurred in another mechanical unit of a bill depositing and payment machine, for example, a bill discrimination unit or in the vicinity of a bill depositing and payment slot, payment and its control are not disclosed.

The present art is provided at least with an upper mechanism having a bill depositing and payment slot that temporarily sets a bill deposited from or paid to a user, a first conveyance path that conveys the bill from or to the bill depositing and payment slot, and a discrimination unit that discriminates the bill. The present art is also provided at least with a lower mechanism having a recycling box that stores the deposited or paid bill, and a second conveyance path that is linked with the cycling box and the first conveyance path and conveys the bill. The present art is also provided with a detector that is arranged in the upper mechanism and the lower mechanism and detecting an abnormal condition of the bill, and a payment mechanical unit that is linked with the second conveyance path of the lower mechanism and ejects the bill for the user. The present art is also provided with a control unit that receives a signal from the detector, and determines the abnormal condition. If the control unit determines the abnormal condition as an abnormality in the upper mechanism, a function of the upper mechanism is stopped, the second conveyance path and the payment mechanical unit are operated, and the bill is dispatched from the recycling box to be conveyed to the payment mechanical unit to be ejected.

In a preferable example, the detector includes an optical sensor, and the control unit receives the signal from the sensor, and determines that a bill jam has occurred.

The payment mechanical unit is preferably arranged on a side of a second conveyance path rather than at a confluence of a first conveyance path and the second conveyance path, and on a front of the apparatus.

Moreover, the payment mechanical unit is provided at least with a conveyance means that conveys a bill, and a multiple feed detection mechanism that detects multiple sheets of bills are conveyed (multiply-fed) at the same time.

Moreover, the payment mechanical unit is provided with an optical sensor that detects the bill conveyed on the conveyance means. The control unit receives a signal from this sensor, and manages denominations of the bill and the number of bills ejected from the payment mechanical unit.

Moreover, the lower mechanism is furthermore provided with a reject box that stores a rejected bill, and conveys the bill rejected in depositing processing through the first conveyance path and the second conveyance path, then stores the bill in the reject box. Otherwise, when the multiple feed is detected by the multiple conveyance detection mechanism, the lower mechanism conveys the bill through the second conveyance path and stores the bill in the reject box.

Furthermore, an apparatus constructed as an ATM is provided with a body control unit that controls bill depositing and payment dealings, and a customer console that includes a display device that displays guidance for the user's dealings and an input device that performs input. When the body control unit receives a report on an abnormal condition from the control unit, the body control unit controls the dealings so as to display on the display device of the customer console that a payment destination has been changed into a payment mechanical unit.

This art is also grasped as a bill handling method in an ATM. That is, the bill handling method in the ATM is provided with a first payment mode in which a bill to be paid to a user is paid utilizing a bill depositing and payment slot of the bill used in case of normal dealings. The bill handling method is also provided with a step of detecting an abnormality that occurs in a mechanical unit including a discrimination unit for discriminating at least the bill depositing and payment slot and a conveyance path that conveys the bill between the units, and a second payment mode in which the payment is performed from a dedicated payment mechanical unit when the abnormality is detected.

Moreover, in a preferable example, when the abnormality is detected, the bill handling method is provided with a step of displaying on a customer console that a payment destination is changed from the bill depositing and payment slot into the dedicated payment mechanical unit.

### BRIEF DESCRIPTION OF THE DRAWINGS

FIG. 1 is a perspective view showing the appearance of an ATM according to one embodiment of the present art;

FIG. 2 is a control block diagram of the ATM according to the embodiment;

FIG. 3 is a side view showing the composition of a bill depositing and payment machine 10 in the embodiment;

FIG. 4 is a control block diagram showing the control of the bill depositing and payment machine according to the embodiment;

FIG. 5 is a side view showing a mechanism of a dedicated bill payment unit 21 in the bill depositing and payment machine according to the embodiment;

FIG. 6 is a schematic depiction showing the conveyance of a bill in payment dealings of the bill depositing and payment machine;

FIG. 7 is a schematic depiction showing the conveyance of the bill in the payment dealings of the bill depositing and payment machine;

FIG. 8 is a schematic depiction showing the conveyance of the bill in the payment dealings of the bill depositing and payment machine;

FIG. 9 is a schematic depiction showing the conveyance of the bill in depositing dealings of the bill depositing and payment machine;

FIG. 10 is a flowchart showing depositing dealings operation when a jam has occurred in the ATM; and

FIG. 11 is a side view showing the mechanism of the dedicated bill payment unit 21 in the bill depositing and payment machine according to another embodiment.

### DESCRIPTION OF THE PREFERRED EMBODIMENTS

One embodiment of the present art is described below in detail with reference to drawings.

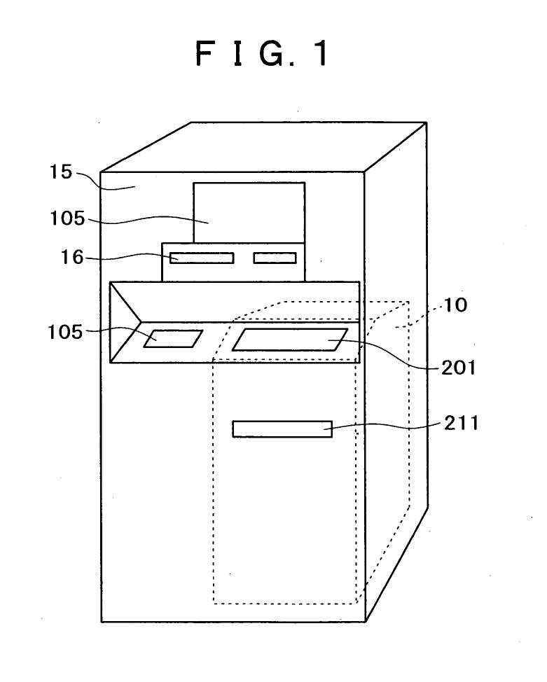

FIG. 1 is a perspective view showing the appearance of an ATM according to the one embodiment.

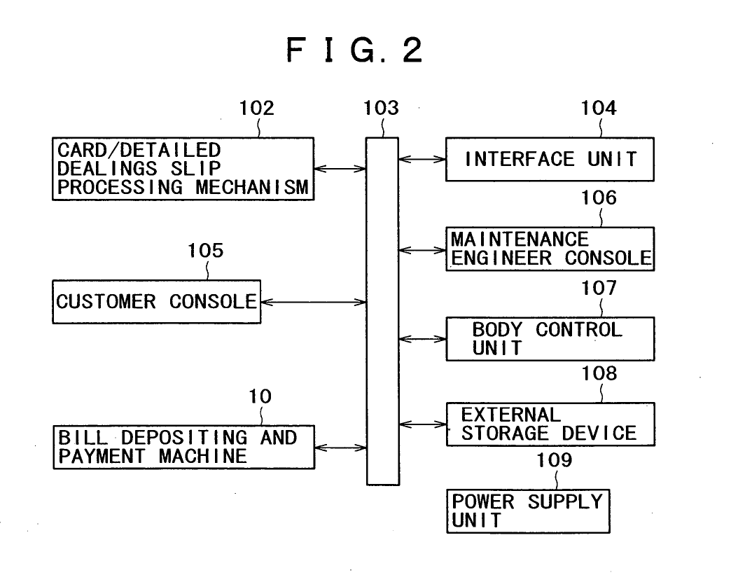

A card slot 16 for inserting a user card is provided on an upper front plate 15 of the ATM cabinet. A card/detailed dealings slip processing mechanism 102 (FIG. 2) that connects with this slot 16, and processes the user card, then prints and releases a detailed dealings slip, as well as a customer console 105 that displays and inputs the contents of dealings to the user are provided. Moreover, a bill depositing and payment machine 10 (or also referred to as a bill handling apparatus) that processes a bill is mounted on the lower side of the ATM, and a bill slot 201 and a dedicated payment slot 211 for a bill depositing and payment slot 20 of the bill depositing and payment machine 10 are arranged on the front of the ATM cabinet. This ATM processes dealings, such as bill depositing, payment, and transfer, by a user using a card or a passbook as a medium.

FIG. 2 is a control block diagram of an ATM according to one embodiment.

The card/detailed dealings slip processing mechanism 102, the bill depositing and payment machine 10, and the customer console 105 mounted in the ATM are connected to a body control unit 107 through a bus 103, and perform required operations under the control of the body control unit 107. The card/detailed dealings slip processing mechanism 102 accepts and processes a user's magnetic card for dealings, and prints and issues a detailed dealings slip. The customer console 105 is provided with a display device, such as a liquid crystal display, that displays guidance for the user's dealings and a touch panel type input device that performs various types of input for the dealings.

The body control unit 107 also connects an interface unit 104, a maintenance engineer console 106, and an external storage device 108 through the bus 103, and transfers required dealings data among these units. Moreover, the body control unit is linked with a host computer through the interface unit 104, and sends and receives the dealings data. The host computer checks correctness of a user and manages an account balance. Further, a power supply unit 109 that supplies each mechanical unit with electric power is provided.

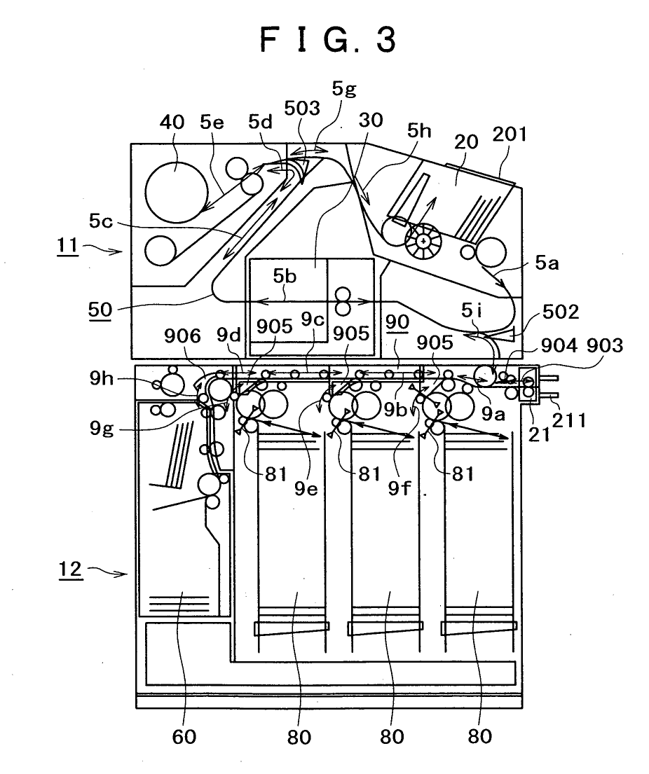

FIG. 3 is a side view showing the composition of the bill depositing and payment machine 10 of the ATM.

The bill depositing and payment machine 10 is divided into an upper mechanism 11 and a lower mechanism 12 as far as the conveyance of a bill is concerned. The upper mechanism 11 is a processing mechanism for bill depositing and payment, and is chiefly provided with units such as the bill depositing and payment slot 20 and a bill discrimination unit 30. To the contrary, the lower mechanism 12 is provided with units, such as recycling boxes 80 and a reject box 60 for storing the bill.

In the upper mechanism 11, the bill depositing and payment slot 20 temporarily sets and holds a bill to be deposited and a bill to be paid when a user puts the former bill and ejects the latter bill. The bill discrimination unit 30 that discriminates the truth (or falsehood), and denominations of the bill is arranged on a conveyance path 50 which connects with the bill depositing and payment slot 20. A temporary storage unit 40 that connects with the conveyance path 50 temporarily stores and holds the bill deposited in the bill depositing and payment slot 20 and discriminated by the bill discrimination unit 30 until dealings are established. Arrows 5a to 5i show bill conveyance directions on the conveyance path 50.

By switching switching gates 502 and 503 arranged in the conveyance path 50, the bill whose dealings are established and that is held in the temporary storage unit 40 passes through a conveyance path 90 from the conveyance path 50 is conveyed into each of the recycling boxes 80 of the lower mechanism 12. Particularly, the switching gate 503 is switched to three directions, and, accordingly, the gate is switched and controlled in three modes. The three modes are adopted when the bill unsuitable as depositing among the bills put from the bill depositing and payment slot 20, when cancellation is selected by a user in depositing dealings, and when the bill is conveyed from the bill depositing and payment slot 20 to the temporary storage unit 40.

Moreover, an optical sensor is also arranged in the gateway of each unit of the bill depositing and payment slot 20, the bill discrimination unit 30, and the temporary storage unit 40. The optical sensor detects the bill that passes through or stored in each unit, and a control unit 70 counts and manages the number of stored bills and the number of transit bills. Further, the sensor arranged in the bill discrimination unit 30 includes a sensor that detects two-sheet feed of the bill, and a sensor that detects the length of the bill in addition to a sensor that determines and discriminates the denominations and truth (or falsehood) of the bill, and also detects the oblique motion, size, and two-sheet feed of the bill.

Optical sensors are installed in each place on the conveyance path 50, and optically detect a conveyed state of the bill. When a bill jam has occurred on the conveyance path 50, these sensors detect the occurrence of the jam.

The multiple recycling boxes 80 that store a bill corresponding to multiple denominations are arranged in the lower mechanism 12. The bill that is stored temporarily in the temporary storage unit 40, and whose depositing dealings were established is conveyed and stored in each of the recycling boxes 80 as payment. The deposited bill that is unsuitable for the payment is stored in the reject box 60.

A roller mechanism, and switching gates 905 and 906 are provided in the upper gateways of each of the recycling boxes 80 and the reject box 60, and the bill is stored and dispatched by driving these mechanism and gates. The conveyance path 90 is linked with these respective recycling boxes 80 and reject box 60, and the bill is conveyed into arrows 9a to 9h. Moreover, the conveyance path 90 is linked with the conveyance path 50, and conveys the bill between it and the upper mechanism 11. An optical sensor (not illustrated) is arranged in the conveyance path 90 and detects a conveyed state of the bill.

A sensor 81 is arranged in the gateway of each of the recycling boxes 80, and detects the transit of a bill. The control unit 70 counts this detection result, and manages the number of bills dispatched from and stored in each of the recycling boxes 80. Furthermore, the control unit 70 monitors the dispatch of the bill and the timing of the sensor transit. When the sensor does not detect the bill regarding the dispatch of the bill, the sensor determines that a jam has occurred.

A dedicated payment unit 21 of a bill peculiar to this embodiment is provided on the front of the lower mechanism 12. When an abnormality such as a bill jam has occurred in the upper mechanism 11, the bill is dispatched from each of the recycling boxes 80, and conveyed on the conveyance path 90 switched by a switching gate 904, then released from this payment slot 21 to the outside. The mechanism of this dedicated payment unit 21 and an abnormal payment control operation will be described further in detail.

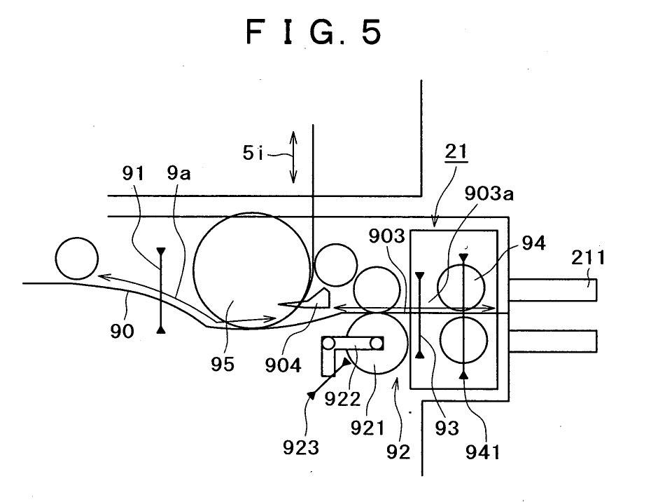

FIG. 5 shows a side view of the dedicated payment unit 21 of a bill.

The dedicated payment unit 21 arranges a conveyance roller 95 on the conveyance path 90 that is opposite to the payment slot 211, and, moreover, a sensor and a detection mechanism conforming to each purpose. That is, multiple length detection sensors 91 for detecting the length of the bill in the conveyance direction 9a are arranged in the vicinity of the bill end in the lengthwise direction of the bill as optical sensors.

Moreover, a multiple feed detection mechanism 92 is provided to detect the conveyance (multiple feed) of two sheets of bills or more. The multiple feed detection mechanism 92 includes a roller 921 that is press-contacted to a bill, a link 922 that supports this press-contacted roller 921 so as to be able to rotate around the axis, and a sensor 923 that optically detects the rear end of the rotating link 922. The bill multiple feed is detected in accordance with a degree in which the rear end crosses the sensor 923.

Furthermore, a tip detection sensor 93 for detecting the tip of a bill, and an exit roller 94 for dispatching, sandwiching, and holding the bill for payment are arranged on the conveyance path 90. The payment slot 211 from which a user receives the bill is provided at the exit. A sensor 941 is arranged in the vicinity of the exit roller 94 so that an optical axis may pass through a roller holding point, and detects whether the bill exists between it and the exit roller 94 or not.

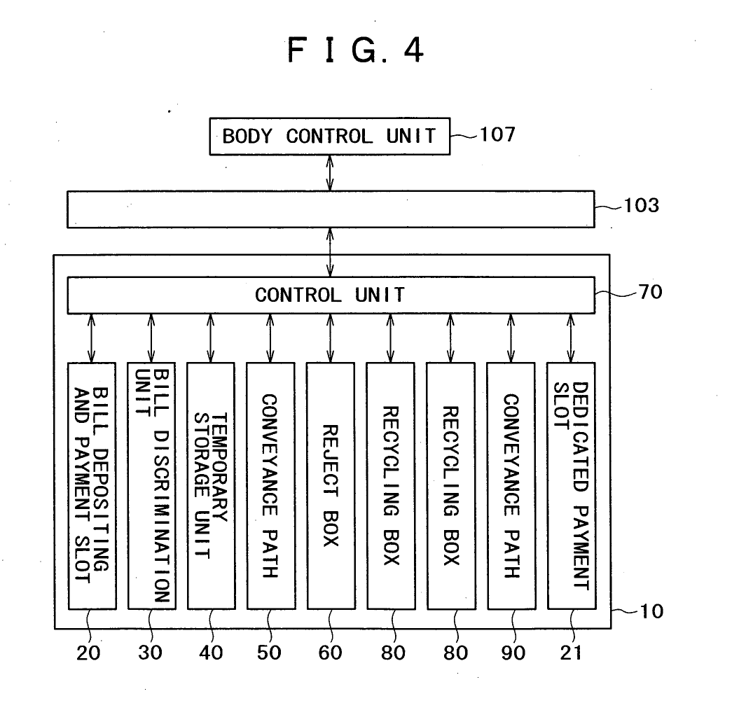

Next, the control of a bill depositing and payment machine is described with reference to the block diagram of FIG. 4.

In FIG. 4, the control unit 70 is connected to the body control unit 107 of a bill handling apparatus through the bus 103, and controls a related unit in accordance with an instruction from the body control unit 107 and the condition detection of the sensor inside the bill depositing and payment machine 10. Moreover, as occasions demand, the state of each unit is sent to the body control unit 107 through the bus 103.

In the bill depositing and payment machine 10, the control unit is connected to the drive motor, solenoid, and sensor of the unit such as the bill depositing and payment slot 20, the bill discrimination unit 30, the temporary storage unit 40, the conveyance paths 50 and 90, the reject box 60, each of the recycling boxes 80, and the dedicated payment slot 21. The control unit drives an actuator, controls the related unit, and conveys, holds, and stores a bill, monitoring a state by the sensor in accordance with dealings.

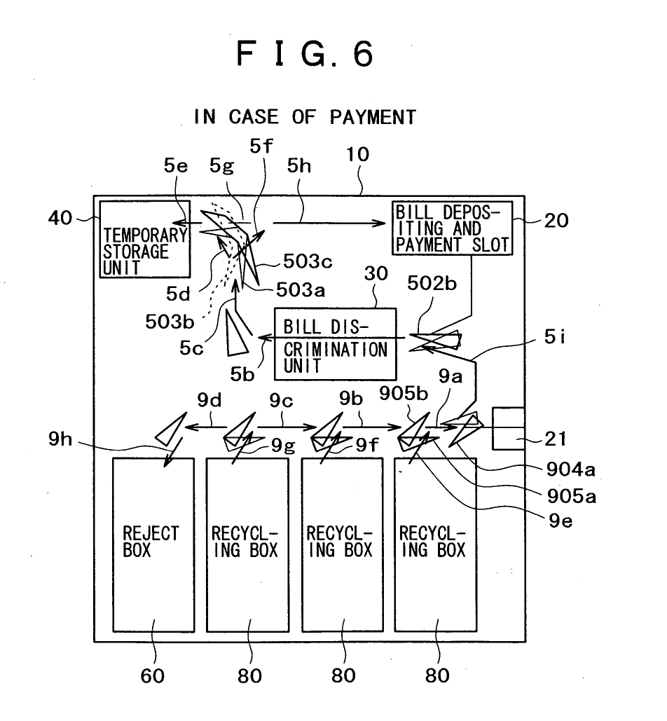

Next, the bill depositing and payment operation in a bill depositing and payment machine is described with reference to the drawing of FIG. 6 or later.

The characteristic of the embodiment of the present art is chiefly the bill payment. When an abnormality has occurred in depositing dealings, the payment dealings be may also affected in some cases. For example, when the depositing dealings are degenerated and shift to the operation of only the payment dealings, the remainder processing of a deposited bill is affected. Preferably, the depositing dealings should be understood for the purpose.

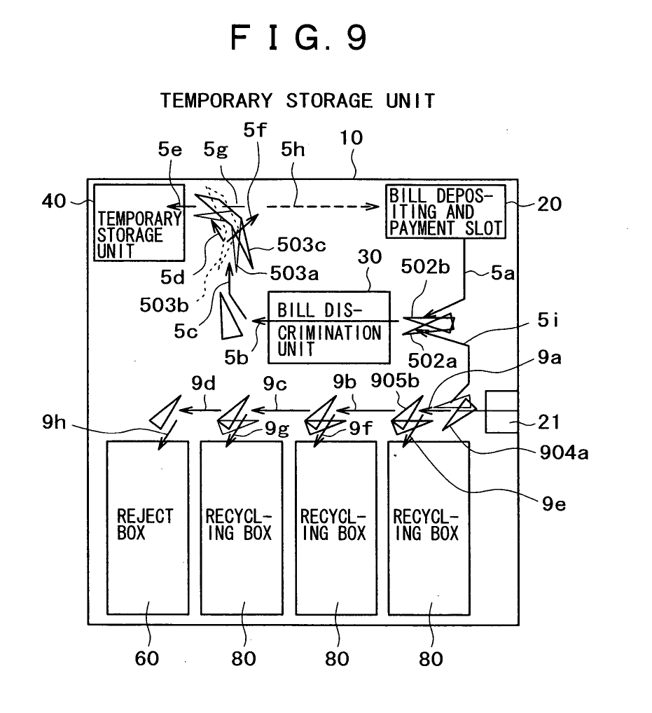

In the schematic depiction of the depositing dealings shown in FIG. 9, the bill put into the bill depositing and payment slot 20 by a user is separated sequentially, and conveyed into the arrows 5a and 5b, then the denominations and truth (or falsehood) of the bill is determined by the bill discrimination unit 30. The bill whose determination has been made allows the switching gate 503 to be switched into a state of 503a, to be conveyed into the directions of the arrows 5c, 5d, and 5e,and to be held once in the temporary storage unit 40. Because the bill that has not been be determined or the bill that is inclined, and the bill in which an abnormality has occurred in the distance between fellow bills are handled as bills whose depositing has been rejected by the bill discrimination unit 30, these bills are not conveyed into the temporary storage unit 40. When the switching gate 503 is switched into a state of 503b, the bills are conveyed in the arrow 5f, returned to the bill depositing and payment slot 20, then returned to the user.

The bill stored in the temporary storage unit 40 is conveyed in the reverse direction with the arrows 5e, 5d, 5c, and 5b at depositing storage. After the bill passes through the bill discrimination unit 30, the switching gate 502 is switched into a state of 502b and the switching gate 904 are switched into and a state of 904, then the bill is conveyed in the directions of the arrows 5i , 9a , 9b, and 9c. Then the switching gate 905 of each of the recycling boxes 80 that corresponds to the denominations to be stored is switched into either state by the control of the control unit 70. For example, as illustrated, the switching gate 905 is switched into a state of 905b, and the bill is stored in each of the specified recycling boxes 80 or the reject box 60.

Further, while a bill is conveyed from the temporary storage unit 40 into each of the recycling boxes 80 or the reject box 60, the bill discrimination unit 30 determines the denominations and truth (or falsehood) of the bill again and may also specify a safe box. The discrimination results of all the bills when the bills are stored in the temporary storage unit 40 in case of depositing count are stored in an ATM memory. When the bills are stored, a recycling box in which the bills are to be stored may also be specified in accordance with the contents stored in the memory.

Moreover, when a deposited bill is cancelled or returned, the switching gate 503 is switched into a state of 503c. The bill is dispatched from the temporary storage unit 40 and conveyed into the reverse directions of the arrows 5e, 5g, and 5h, then returned to the bill depositing and payment slot 20.

Next, a bill conveyance operation in payment dealings is described with reference to FIG. 6 to FIG. 8. In FIG. 6, each of the recycling boxes 80 that corresponds to denominations is specified by the control of the control unit 70 in accordance with a payment sum specified by a user. The switching gate that is provided at the exit of each of the recycling boxes 80 is switched, and a roller mechanism is driven, then the bill for the specified number of bills is dispatched from each of the recycling boxes 80.

Subsequently, a bill is conveyed in the directions of the arrows 9c, 9b, 9a, and 5i, and passes through the bill discrimination unit 30. The bill discrimination unit 30 discriminates the presence of the superimposition (multiple feed) of two sheets of bills or more, and the posture, denominations, and truth (or falsehood) of the bill. The bill that is determined to be normal by the discrimination unit 30 branches in the switching gate 503b subsequently, and is conveyed in the direction of the arrow 5h. Then the bill is set in the bill depositing and payment slot 20 and paid to the user.

On the other hand, when a bill is determined as an unusual bill (abnormal bill) by the bill discrimination unit 30, and a reject has occurred, the abnormal bill allows the switching gate 503 to be switched into the state of 503a, and to be conveyed from the direction of the arrow 5d to the temporary storage unit 40, then to be held in the temporary storage unit once in the same manner as in the case of depositing count. An insufficient, rejected bill is additionally dispatched from each of the corresponding recycling boxes 80.

The bill held in the temporary storage unit 40 when a reject has occurred is conveyed so as to be stored in the reject box 60. That is, a rejected bill is sent out in the reverse directions of the arrows 5e and 5d from the temporary storage unit 40 as illustrated, and conveyed in the reverse directions of the arrows 5c and 5b, then passes through the bill discrimination unit 30. The bill discrimination unit 30 discriminates the denominations and truth (and falsehood) of the bill. As a result, a discriminable bill is conveyed in the reverse directions of the arrows 5i, 9a, 9b, and 9c, and collected in each of the reject boxes 80 that corresponds to the denominations.

To the contrary, the bill that cannot be discriminated by the bill discrimination unit 30 is conveyed in the reverse directions of the arrows 5i, 9a, 9b, and 9c in the same manner, and stored in the reject box 60. Accordingly, the number of rejected bills may be reduced, and fund efficiency is improved.

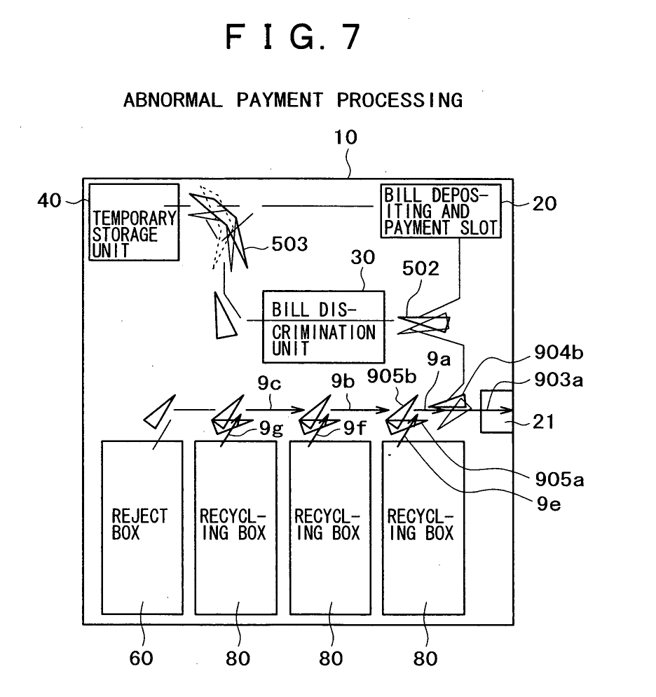

Next, a payment operation when a bill jam has occurred is described with reference to FIG. 7. When an abnormality such as the jam has occurred in the upper mechanism 11, the conveyance path 50 of the upper mechanism 11 is stopped by the control of the control unit 70, and the payment operation is performed by the mechanism of only the lower mechanism 12.

The bill for the number of bills specified per denomination is dispatched sequentially from each of the recycling boxes 80 of the denominations specified by the control unit 70. The bill dispatched is conveyed in the directions of the arrows 9c, 9b, and 9a, and furthermore conveyed into the roller 95. Then the bill switched into a state of 904b passes through the switching gate 904 and is sent to a conveyance path 903. Then the bill is released into the exit slot 211 from the tip of the dedicated payment unit 21. This operation is repeated until the specified number of bills is reached.

Thereupon, as shown in FIG. 5, a bill dispatched in the dedicated payment unit 21 allows bill length to be measured by the length detection sensor 91 first. Subsequently, the multiple feed detection mechanism 92 detects that the bill is not multiply-fed. The bill that passed through the multiple feed detection mechanism 92 allows the position of the tip to be detected by the tip detection sensor 93 and to be dispatched to the exit rollers 94. At this time, the dispatched amount of the bill is calculated from the position of the tip and the bill length so that the bill may not be fully dispatched from the exit roller 94. Subsequently, the bill is conveyed a predetermined amount, and the exit roller 94 is stopped with the bill sandwiched between the exit rollers 94 and held there.

When the user extracts the bill sandwiched between the exit rollers 94 from the payment slot 211, the user detects that the bill is extracted from the sensor 941, and dispatches a subsequent bill from each of the recycling boxes 80.

A payment operation of the bill per sheet is repeated in this manner through the dedicated payment unit 21. Subsequently, when the number of bills for a specified sum is reached, the payment operation is terminated.

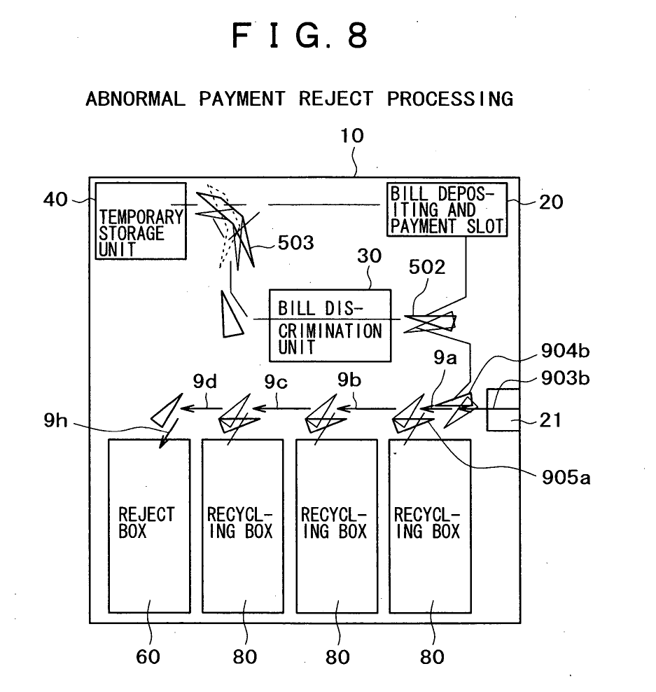

Next, an abnormal payment reject operation is described with reference to FIG. 8.

The multiple feed detection mechanism 92 provided in the dedicated payment unit 21 detects the conveyance of two sheets of bills or more (in abnormal payment). Subsequently, when the tip detection sensor 93 detects the tip of the bill, the rotation of the roller 95 and the exit roller 94 is stopped, and the conveyance of the bill is stopped. Accordingly, the bill is stopped at the position where the bill will not be extracted by the user.

Subsequently, processing shifts to the abnormal payment reject operation (FIG. 8). At this occasion, a bill is conveyed from the dedicated payment unit 21 to an arrow 903a and the arrows 9a to 9d, and 9h as illustrated, and stored in the reject box 60. Subsequently, the bill is dispatched from each of the recycling boxes 80 that corresponds to the rejected bill again. A subsequent payment operation is shown in FIG. 7.

Further, the payment operation using the dedicated payment unit 21 continues while a jam of the upper mechanism 11 is not being recovered yet. If the upper mechanism 11 is recovered, however, the normal payment operation using the upper mechanism 11 is returned.

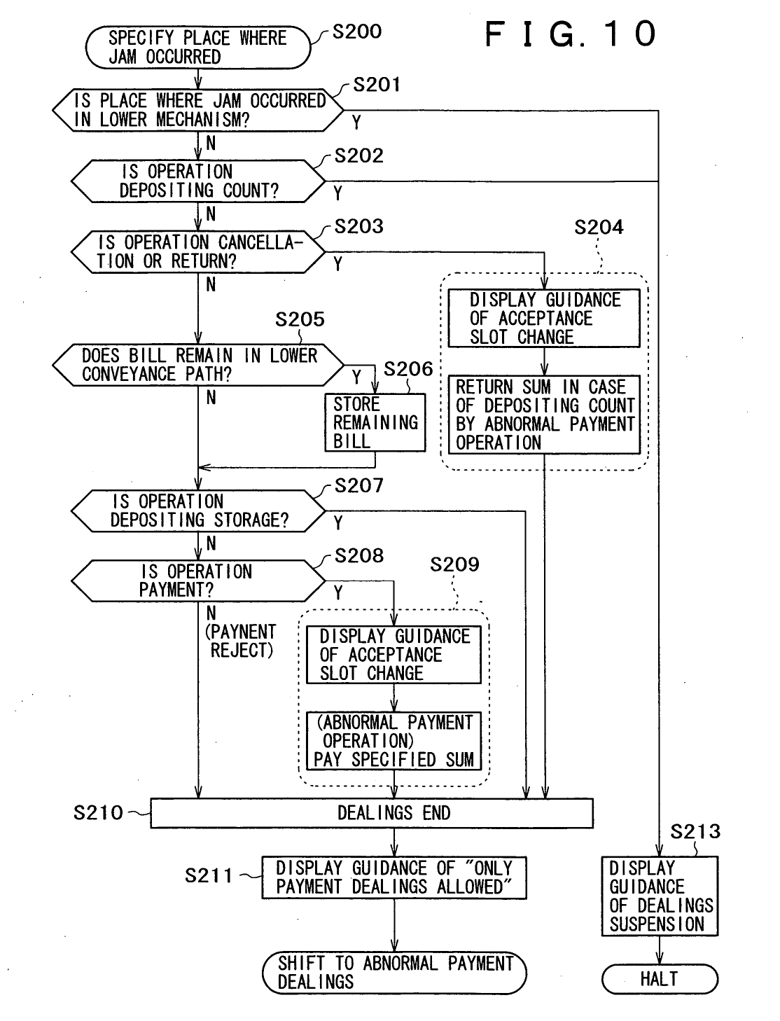

Next, the payment operation accompanied by the occurrence of a jam in the ATM is described with reference to the flowchart of FIG. 10.

The control unit 70 of a bill depositing and payment machine detects and processes a detection signal from sensors arranged in the conveyance paths 50 and 90 of the upper mechanism 11 and the lower mechanism 12 and each of the units 20, 30, 40, 60, and 80. In any one of the conveyance paths or these units, when the bill jam has occurred and the normal bill conveyance became difficult, the control unit 70 specifies the place where the jam has occurred (S200). That is, the number of stored bills and the dispatch of the bill in each unit are detected using a signal from the sensor provided in each unit. Moreover, a conveyed state of the bill on each conveyance path is detected using a signal from the sensor of the conveyance path. The place where the jam has occurred is specified determining from the signals of these sensors. Subsequently, whether the place where the jam has occurred is at the lower mechanism 12 is determined (S201). When the place is at the lower mechanism 12, disabled handling of the bill is notified the body control unit 107 of through the bus 103. The body control unit 107 determines the disabled bill handling as bill depositing and payment dealings in an ATM, and displays guidance indicating “dealings continuation disabled” on the customer console 105 (S213), then halts the dealings.

On the other hand, as a result of the above determination (S201), when the place where the am has occurred is determined as the upper mechanism 11, the following operation is performed in accordance with respective dealings.

First, when the jam has occurred in the upper mechanism 11 in depositing count (the depositing and payment slot 20→the bill discrimination unit 30→the temporary storage box 40), a deposited sum (S202) cannot be determined due to intermediate count. Because the deposited bill must be returned, however, in this example, dealings are halted (S202Y) in the same manner as the case in which the jam has occurred at the lower mechanism 12. However, a depositing count operation is the control operation that is performed chiefly the bill discrimination unit 30, the temporary storage unit 40, and the conveyance path 50 of the upper mechanism 11, the bill will not remain at the lower mechanism 12. Accordingly, the lower mechanism 12 is made movable and payment dealings may be performed.

When the jam has occurred (S203) at the upper mechanism 11 in case of depositing cancellation or return (the temporary storage box 40→the bill depositing and payment slot 20), a bill cannot be dispatched from the temporary storage unit 40 to the bill depositing and payment slot 20. In this case, the body control unit 107 displays on the customer console 105 guidance indicating that the place where the bill is received is changed from the bill depositing and payment slot 20 to the dedicated payment unit 21. The lower mechanism 12is controlled so as to perform the operation of FIG. 7 and FIG. 5, and the bill of the same sum as counted in the depositing count from the dedicated payment unit 21 is returned to the user (S204). After the bill is returned and the dealings are terminated (S210), the body control unit 107 displays the guidance indicating “only payment dealings enabled” on the customer console 105 (S211). Subsequently, processing shifts to the application of an abnormal payment operation until a maintenance engineer reaches the ATM, and continues the dealings.

If a jam has occurred in the upper mechanism 11 in depositing storage (the temporary storage box 40→the bill discrimination unit 30→each of the recycling boxes 80), in depositing (each of the recycling boxes 80→the bill discrimination unit 30→the bill depositing and payment slot 20), or in a payment reject operation (each of the recycling boxes 80→the bill discrimination unit 30→the temporary storage unit 40), first, whether the bill that is being conveyed exists at the lower mechanism 12 is detected using a signal from the sensors provided in each unit and conveyance path. If a signal from a sensor that detects the transit state of the bill of the lower mechanism 12 is checked (S205), and it is determined that the bill exists in the conveyance path 90, the bill that is being stored is stored in the reject box 60 or each of the recycling boxes 80 (S206).

Next, the body control unit 107 checks whether the operation of a bill is a depositing operation (S207). If the operation is the depositing storage (S207Y), a dealings end occurs (S210). Subsequently, the body control unit 107 displays the guidance indicating “only payment dealings enabled” on the customer console 105 (S211). Subsequently, processing continues the dealings according to the application of the abnormal payment operation until a maintenance engineer is reached.

Next, the body control unit 107 checks whether the operation of the bill is a payment operation (S208). When the operation is the payment operation (S208), the body control unit displays the guidance indicating that the acceptance slot of the bill is changed from the bill depositing and payment slot 20 into the dedicated payment unit 21 on the customer console 105 (S209). In this case, the control unit 107 controls the payment of the bill shown in FIG. 7 and FIG. 5, and releases the bills of the sum specified by the user one by one from the dedicated payment unit 21 (S209) sequentially. The dealings terminate with this payment operation against the relevant user when an ATM jam has occurred. Further, in this case, the account balance of the relevant user managed by a host computer is updated using a command sent from the body control unit 107 through the interface unit 104.

Subsequently, the body control unit 107 displays the guidance indicating “only payment dealings enabled” or “special-purpose payment dealings” on the customer console 105 in order to switch into only the payment dealings using the dedicated payment unit 21 (S211). Subsequently, until a maintenance engineer is reached, an abnormal payment operation continues.

Further, in the above payment determination (S208), when the operation is determined as a payment reject, the same operation as in case of the bill depositing storage is performed, and subsequently, processing shifts to the application of an abnormal payment.

According to the one embodiment described above, when an abnormality such as the jam has occurred in the upper mechanism 11, the bill may be continuously paid utilizing each of the recycling boxes 80, the bill conveyance path 90, and the dedicated payment unit 21 of the lower mechanism 12.

Moreover, because the dedicated payment unit 21 is provided on the front side rather than at the confluent between the path 5a of the deposited bill and the path 5i of the paid bill of the conveyance path 50 arriving at the bill discrimination unit 30 from each of the recycling boxes 80, that is, ahead of the conveyance path 90 on the side of each of the recycling boxes 80, the conveyance path 90 of each of the recycling boxes 80 and the dedicated payment unit 21 may be shortened. Accordingly, the structure of a bill conveyance mechanism may be simplified, and the bill conveyance time may also be shortened, then dealings time may be saved.

Furthermore, because the multiple feed detection mechanism 92 that detects the multiple feed of a bill between the dedicated payment unit 21 and each of the recycling boxes 80 is provided, multiple bills are prevented from being dispatched at the same time. Moreover, the multiple feed detection mechanism 92 is provided immediately in front of the dedicated payment unit 21. Accordingly, even when the multiple bills are dispatched from any one of the multiple recycling boxes 80, all the paid bills that use the dedicated payment unit 21 may be discriminated by the single detection mechanism 92.

Further, the present art is not limited to the above embodiment and may be modified variously and executed.

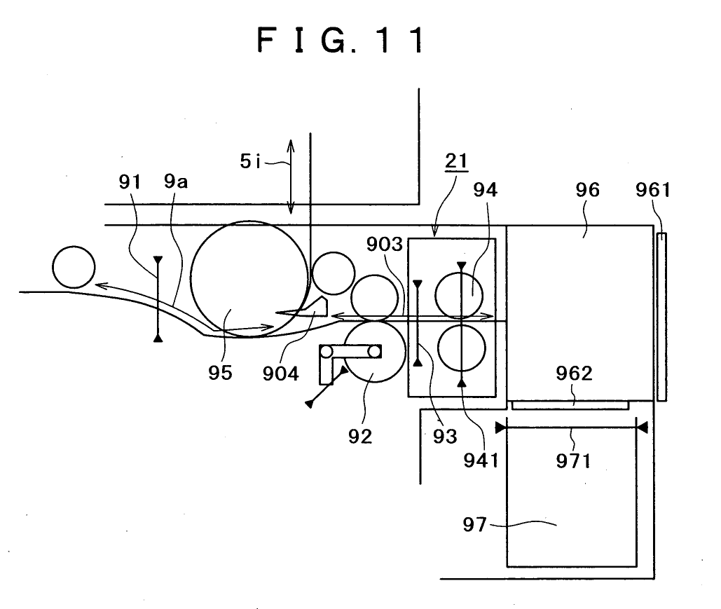

FIG. 11 shows a modification related to the dedicated payment unit 21.

In the example referenced in the above FIG. 5, bills are released from the exit slot 211 sequentially. To the contrary, in the example shown in FIG. 11, a bill storage unit 96 that temporarily stores a paid bill, and a payment reject box 97 that temporarily stores a rejected bill are provided at the exit of the dedicated payment unit 21. According to this example, the front stage portion of a bill conveyance operation is the same as FIG. 5, but differs in the state of the bill released from a conveyance path and the handling of the rejected bill.

An acceptance slot shutter 961 that may be moved downward is mounted on the front of the bill storage unit bill 96, and a reject shutter 962 that may be moved crosswise (in the direction vertical to the page space of FIG. 11) is mounted at the lower part. A sensor 971 that detects a full state of the bill is mounted at the gateway of the payment reject box 97.

Speaking of a payment operation, a bill conveyed continuously is released into the bill storage unit 96, and stored temporarily there. The acceptance shutter 961 moves downward in that state and the front of the storage unit 96 opens, then the bill is paid to a user. When the multiple feed of the bill is detected by the multiple feed detection mechanism 92, the reject shutter 962 opens, and all the bills inside the storage unit 96 drop into the payment reject box 97 that is provided immediately under the storage unit 96, then are stored there. Subsequently, the payment operation for the relevant user is performed from the first again.

Because a user may receive a bill collectively, this example is convenient for the user.

According to a further example, in the payment dealings using the dedicated payment unit 21, the guidance of the purpose is displayed on the customer console 105. Additionally, for example, a lamp and a light emitting element are provided at an appropriate place of the payment slot 211 of the dedicated payment unit 21 shown in FIG. 5, or of the shutter 961 of FIG. 11. A user may be urged to change a payment slot by turning on the lamp and light emitting element in payment.

The control unit 70 of the bill depositing and payment machine of FIG. 4 may be used both by the body control unit 107 shown in FIG. 2, and the body control unit 107 may also control all units.

Further, an abnormality includes a sensor fault, adhesion of foreign matters into a sensor, and an abnormality of an object mechanical unit monitored by the sensor as well as a bill jam. These abnormalities are detected by the control unit 70, and the same payment operation as described above is performed.

According to the present art, even when a jam has occurred in a mechanism including a unit portion that performs bill depositing and payment processing in a bill handling apparatus, a bill payment operation may be continuously performed using a dedicated payment destination.

1. A bill handling apparatus that handles a bill, comprising:
an upper mechanism including a bill depositing and payment slot that temporarily sets a bill deposited from or paid to a user, a first conveyance path that conveys the bill from or to the bill depositing and payment slot, and a discrimination unit that discriminates the bill arranged in the first conveyance path;
a lower mechanism including a recycling box that stores the deposited or paid bill, and a second conveyance path that is linked with the recycling box and the first conveyance path and conveys the bill;
a detector that is arranged in the upper mechanism and the lower mechanism and detects an abnormal condition of the bill;
a payment mechanical unit that is linked with the second conveyance path of the lower mechanism and ejects the bill; and
a control unit that receives a signal from the detector, and determines the abnormal condition, wherein
when the control unit determines the abnormal condition as an abnormality in the upper mechanism, a function of the upper mechanism is stopped, the second conveyance path and the payment mechanical unit are operated, and the bill is dispatched from the recycling box to be conveyed into the payment mechanical unit and ejected.

2. The bill handling apparatus according to claim 1,
wherein the detector includes an optical sensor, and
the control unit receives the signal from the sensor, and determines that a bill jam has occurred.

3. The bill handling apparatus according to claim 1, wherein the payment mechanical unit is arranged on a side of the second conveyance path rather than at a confluent between the first conveyance path and the second conveyance path, and on a front of the apparatus.

4. The bill handling apparatus according to claim 1, wherein the lower mechanism includes a multiple feed detection mechanism for detecting that a plurality of bills are superimposed and conveyed.

5. The bill handling apparatus according to claim 4,
wherein the lower mechanism includes a reject box that stores a rejected bill, and
when the multiple feed detection mechanism detects a multiply-fed bill, the control unit conveys the multiply-fed bill through the second conveyance path, and stores the multiply fed bill in the reject box.

6. The bill handling apparatus according to claim 1, wherein the payment mechanical unit includes a bill storage unit that temporarily stores a bill and a payment reject unit that stores a rejected bill unsuitable for payment.

7. The bill handling apparatus according to claim 1,
wherein the payment mechanical unit includes an optical sensor that detects the bill conveyed from the second conveyance path, and
the control unit receives a signal from the sensor, and manages denominations of the bill and the number of bills ejected from the payment mechanical unit.

8. An automated teller machine (ATM) that automatically deals with cash, comprising:
a customer console including a display function that displays guidance for dealings of a user and an input function that performs input;
a bill handling apparatus that handles a bill; and
a body control unit, wherein
the bill handling apparatus has an upper mechanism including a bill depositing and payment slot from and to which the bill is deposited and paid, and a discrimination unit that discriminates the bill as well as a lower mechanism including a plurality of recycling boxes that stores the bill per denomination, and a dedicated payment unit that is provided exclusively for bill payment, and
the body control unit displays on the customer console that a payment destination of the bill is changed into the dedicated payment unit when an abnormality of the upper mechanism is detected.

9. The ATM according to claim 8, wherein the bill handling apparatus conveys a bill of the same sum as discriminated by the discrimination unit from the recycling box and ejects the bill from the dedicated payment unit when the abnormality has occurred in payment cancellation or return.

10. The ATM according to claim 8, wherein
the bill handling apparatus conveys the bill from the recycling box, and ejects the bill from the dedicated payment unit when the abnormality has occurred in payment, and
the body control unit displays on the customer console that the dedicated payment unit is used exclusively for payment dealings.

11. A bill handling method, comprising the steps of;
temporarily setting a bill to be deposited from or paid to a user using a bill depositing and payment slot utilized in normal dealings;
conveying the bill provided in the bill depositing and payment slot via a first conveyance path in order to discriminate the bill by a discrimination unit;
detecting an abnormality that occurs in a mechanical unit including the bill depositing and payment slot, the discrimination unit, and the first conveyance path; and
stopping a payment operation of the bill using the mechanical unit, and performing payment from a dedicated payment mechanical unit when the abnormality is detected.

12. The bill handling method according to claim 11, comprising the steps of:
conveying, in the abnormality, the bill dispatched from a recycling box that stores the bill in the bill depositing and payment slot via a second conveyance path to the payment mechanical unit; and
conveying, in the normality, the bill dispatched from the recycling box to the bill depositing and payment slot via the second conveyance path and the first conveyance path.

13. The bill handling method according to claim 11, comprising the steps of:
detecting an abnormality of conveyance of a bill in the payment mechanical unit by a sensor provided in the payment mechanical unit; and
conveying an abnormal bill to a reject box via the second conveyance path when the abnormality is detected in the payment mechanical unit.

14. A bill handling method for processing a bill by an ATM that deposits and pays the bill, comprising the steps of:
a first payment for paying the bill paid to a user using a bill depositing and payment slot of the bill used in normal dealings;
detecting an abnormality that occurs in a mechanical unit including the bill depositing and payment slot, a discrimination unit that discriminates the bill, and a conveyance path through which the bill is conveyed between the slot and unit; and
a second payment for performing payment from a dedicated payment mechanical unit when the abnormality is detected.

15. The bill handling method according to claim 14, further comprising a step of displaying on a customer console that a payment destination is changed from the bill depositing and payment slot to t he dedicated payment mechanical unit when the abnormality is detected.

16. The bill handling method according to claim 14, wherein the detection of the abnormality includes a step of detecting a bill jam.
